(19) United States
(12) Patent Application Publication
(10) Pub. No.: US 2026/0088641 A1
(43) Pub. Date: Mar. 26, 2026

(54) PORTABLE CAMERA BATTERY CHARGING DEVICE

(71) Applicant: Shenzhen Haohaisheng Technology Co., Ltd., Shenzhen (CN)

(72) Inventor: Hailin MA, Guiping (CN)

(21) Appl. No.: 18/895,558

(22) Filed: Sep. 25, 2024

(51) Int. Cl. H02J 7/00; G03B 17/56

(52) U.S. Cl. CPC H02J 7/751; G03B 17/56; G03B 2217/007

(57) ABSTRACT

The present disclosure discloses a portable camera battery charging device, which includes a bin body and a bin cover, wherein an inner bin is fixed at the top of the bin body, the bin cover covers the top of the inner bin, the edge of the bin cover is hingedly connected to the bin body, the top of the inner bin is provided with two receiving cavities that match the appearances of camera batteries, the bottom of each receiving cavity is provided with a charging plug that is electrically connected with the camera battery in a plug-in manner, a charging control board and a built-in battery are fixed in a space formed by the inner bin and the bin body, and the charging plugs and the built-in battery are electrically connected to the charging control board respectively.

### TECHNICAL FIELD

The present disclosure relates to a camera battery charger, and in particular to a portable camera battery charging device.

### BACKGROUND ART

A camera charger is a device used to store a camera battery in a plug-in manner and can be used to charge the battery. However, existing chargers can only be used to store batteries and still require an adapter to be connected when charging. For relevant mechanisms, please refer to the Chinese patent document No. CN217935140U, entitled “Charger for camera batteries of various specifications”, which records: “A camera battery charger is provided by setting battery charging chambers to include an LP-E12 battery charging chamber, an LP-E17 battery charging chamber and an LP-E6 battery charging chamber, wherein the LP-E12 battery charging chamber and the LP-E17 battery charging chamber are arranged in parallel in a vertical direction, and an isolation zone is provided between the LP-E12 battery charging chamber and the LP-E17 battery charging chamber; the LP-E6 battery charging chamber passes through the isolation zone in the vertical direction and extends to the LP-E12 battery charging chamber and the LP-E17 battery charging chamber respectively, overlapping with the LP-E12 battery charging chamber and the LP-E17 battery charging chamber. The bottom of the LP-E12 battery charging chamber is provided with an LP-E12 battery charging spring pin, the bottom of the LP-E17 battery charging chamber is provided with an LP-E17 battery charging spring pin, the bottom of the LP-E6 battery charging chamber is provided with an LP-E6 battery charging plugging sheet, and the LP-E6 battery charging plugging sheet is provided at the bottom of the side surface of the isolation belt, so that it is compatible with the charging of LP-E12 batteries, LP-E17 batteries and LP-E6 batteries.”

In this type of mechanism, the battery charging chambers provided therein only have the function of accommodating the camera battery and charging the battery through a spring. In practical applications, it is necessary to connect an further adapter through a USB interface, so the usage scenarios are limited and the device lacks portability.

### SUMMARY

The technical problem to be solved by the present disclosure is to provide a portable camera battery charging device which can not only store a camera battery but also realize a mobile charging function, in view of the deficiencies of the prior art.

In order to solve the above technical problem, the technical solution used by the present disclosure is as follows.

A portable camera battery charging device includes a bin body and a bin cover, wherein an inner bin is fixed at the top of the bin body, the bin cover covers the top of the inner bin, the edge of the bin cover is hingedly connected to the bin body, the top of the inner bin is provided with two receiving cavities that match the appearances of camera batteries, the bottom of each receiving cavity is provided with a charging plug that is electrically connected with the camera battery in a plug-in manner, a charging control board and a built-in battery are fixed in a space formed by the inner bin and the bin body, and the charging plugs and the built-in battery are electrically connected to the charging control board respectively.

Preferably, elastic clamping arms for clamping the camera batteries are respectively formed on inner walls of two sides of the receiving cavities.

Preferably, two indicator light boards are provided on the inner side of the inner bin, the indicator light boards are electrically connected to the charging control board, the indicator light boards include indicator lights, the two indicator lights pass through the top of the inner bin respectively, and the two indicator lights are arranged adjacent to the two receiving cavities respectively.

Preferably, an upper magnet is embedded in the edge of the bin cover, a lower magnet is embedded in the edge of the inner bin, and the upper magnet and the lower magnet are aligned and magnetically attracted to each other.

Preferably, two built-in batteries are provided in the space formed by the inner bin and the bin body, and the inner walls of the bin body are provided with ribs which are closely matched with the built-in batteries.

Preferably, a Type-C interface is provided on the charging control board, and an opening aligned with the Type-C interface is provided in the side wall of the bin body.

In the portable camera battery charging device disclosed in the present disclosure, the bin body, the bin cover and the inner bin constitute a basic structure of the shell, and the two receiving cavities at the top of the inner bin are used to store the camera batteries in a plug-in manner, and the charging plugs at the bottoms of the receiving cavities are used to be electrically connected with the camera batteries in a plug-in manner. In this case, the charging control board can obtain electric power from the built-in battery and charge the camera batteries. Compared with the prior art, the present disclosure can not only realize a storage function for camera batteries, but also realize a mobile charging function, thus better meeting application requirements.

### BRIEF DESCRIPTION OF THE DRAWINGS

FIG. 1 is a perspective view of a portable camera battery charging device in a closed state;

FIG. 2 is a perspective view of the portable camera battery charging device in an opened state;

FIG. 3 is a first exploded view of the portable camera battery charging device of the present disclosure;

FIG. 4 is a second exploded view of the portable camera battery charging device of the present disclosure;

FIG. 5 is a structural view of an inner bin and camera batteries;

FIG. 6 is a structural view of a bin body; and

FIG. 7 is a structural view of the bin body and inner bins of different specifications.

### DETAILED DESCRIPTION OF EMBODIMENTS

The following describes the present disclosure in more detail with reference to the drawings and embodiments.

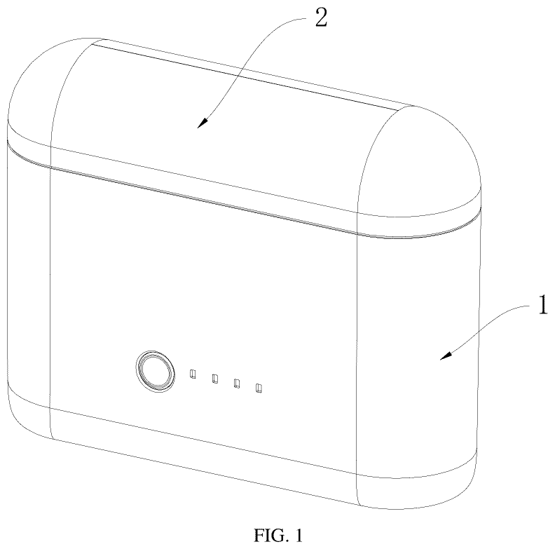

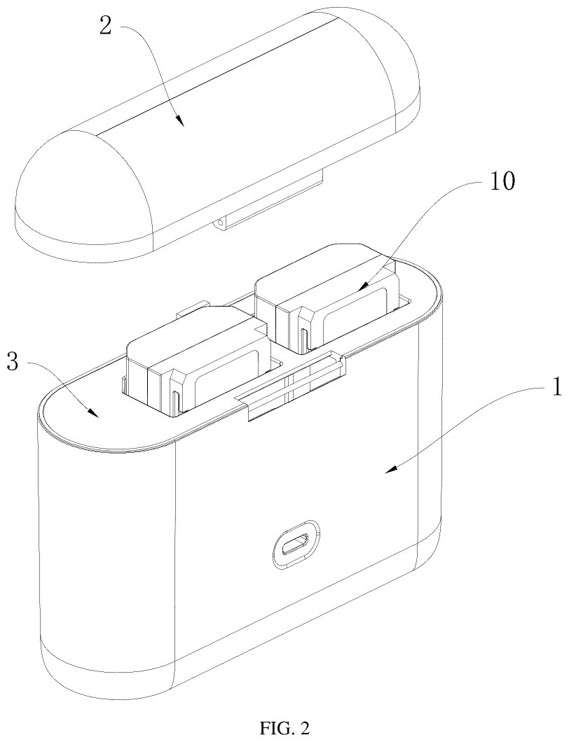

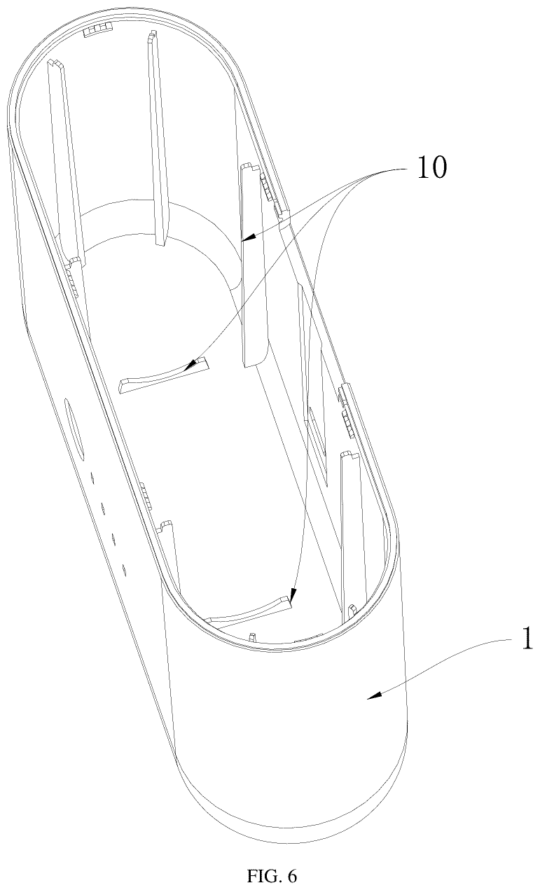

The present disclosure discloses a portable camera battery charging device, as shown in FIGS. 1 to 6, which includes a bin body 1 and a bin cover 2, wherein an inner bin 3 is fixed at the top of the bin body 1, the bin cover 2 covers the top of the inner bin 3, the edge of the bin cover 2 is hingedly connected to the bin body 1, the top of the inner bin 3 is provided with two receiving cavities 30 that match the appearances of camera batteries 100, the bottom of each receiving cavity 30 is provided with a charging plug 31 that is electrically connected with the camera battery 100 in a plug-in manner, a charging control board 4 and a built-in battery 5 are fixed in a space formed by the inner bin 3 and the bin body 1, and the charging plugs 31 and the built-in battery 5 are electrically connected to the charging control board 4 respectively.

In the above structure, the bin body 1, the bin cover 2 and the inner bin 3 constitute a basic structure of the shell, and the two receiving cavities 30 at the top of the inner bin 3 are used to store the camera batteries 100 in a plug-in manner, and the charging plugs 31 at the bottoms of the receiving cavities 30 are used to be electrically connected with the camera batteries 100 in a plug-in manner. In this case, the charging control board 4 can obtain electric power from the built-in battery 5 and charge the camera batteries 100. Compared with the prior art, the present disclosure can not only realize a storage function for camera batteries, but also realize a mobile charging function, thus better meeting application requirements.

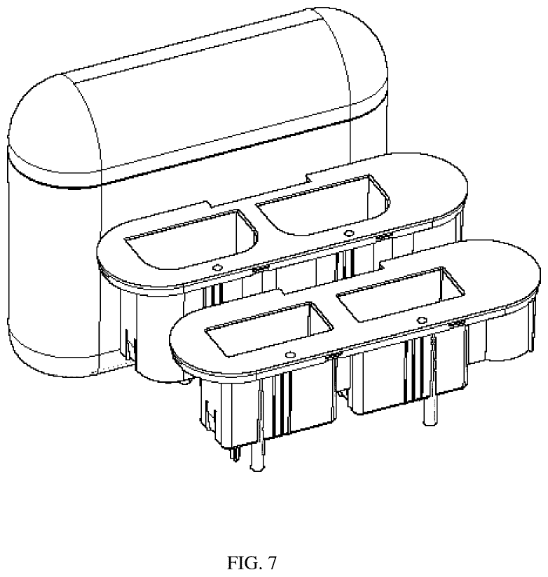

Referring to FIG. 7, according to the present disclosure, in practical applications, different types of inner bins 3 can be designed according to the appearances of the camera batteries 100, so that the receiving cavities 30 and the camera batteries 100 can be matched with each other.

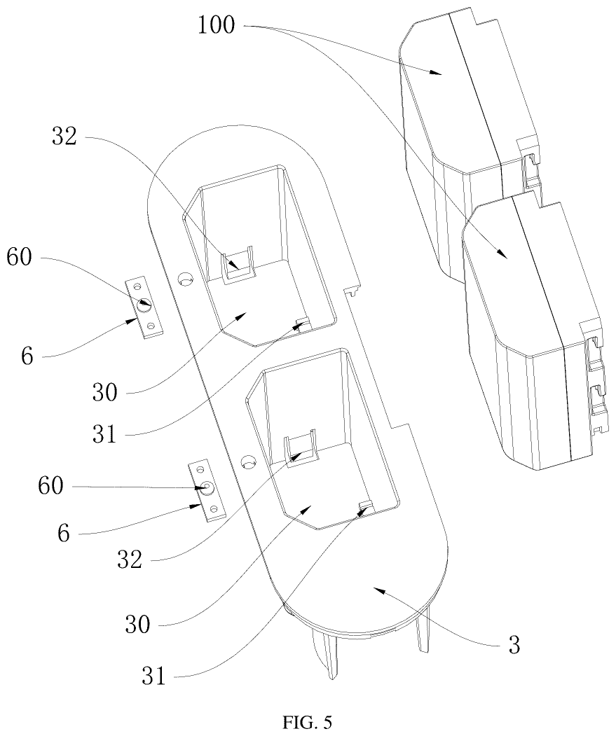

Referring to FIG. 5, when the camera batteries 100 are stored in the receiving cavities 30, in order to position the camera batteries 100, in this embodiment, elastic clamping arms 32 for clamping the camera batteries 100 are respectively formed on inner walls of two sides of the receiving cavities 30.

In a preferred manner, two indicator light boards 6 are provided on the inner side of the inner bin 3. The indicator light boards 6 are electrically connected to the charging control board 4. The indicator light boards 6 include indicator lights 60. The two indicator lights 60 pass through the top of the inner bin 3 respectively. The two indicator lights 60 are arranged adjacent to the two receiving cavities 30 respectively. In the above structure, the indicator lights 60 on the indicator light boards 6 are used to show the charging states of the camera batteries 100 in respective adjacent receiving cavity 30.

In this embodiment, the bin cover 2 and the inner bin 3 are in a magnetically attracted cooperation relationship. Specifically, an upper magnet 20 is embedded in the edge of the bin cover 2, and a lower magnet 33 is embedded in the edge of the inner bin 3. The upper magnet 20 and the lower magnet 33 are aligned and magnetically attracted to each other.

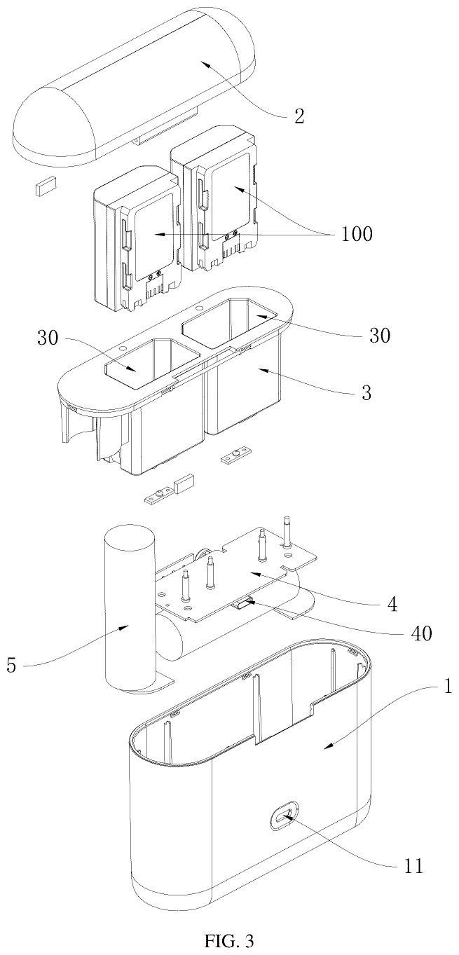

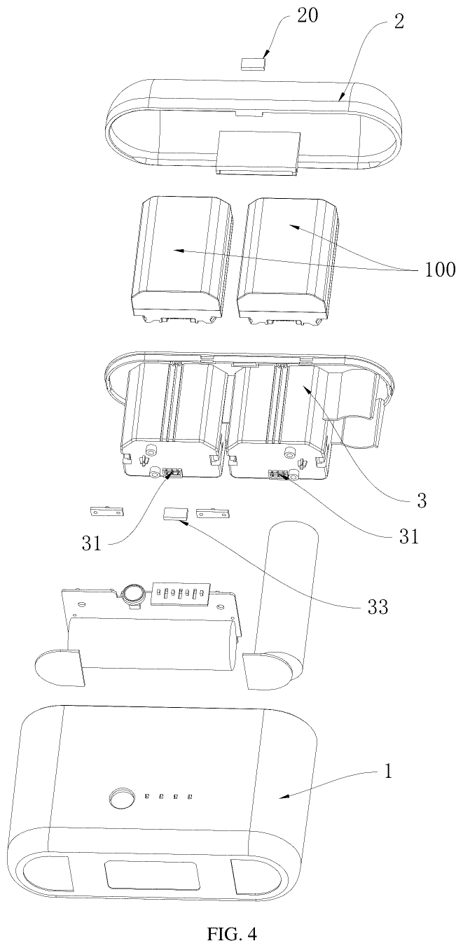

In order to store sufficient electric power, in this embodiment, two built-in batteries 5 are provided in the space formed by the inner bin 3 and the bin body 1, and the inner walls of the bin body 1 are provided with ribs 10 which are closely matched with the built-in batteries 50. Referring to FIG. 3 and FIG. 4, the two built-in batteries 5 in this embodiment are in an upright state and a horizontal state respectively.

In a preferred manner, a Type-C interface 40 is provided on the charging control board 4, and an opening 11 aligned with the Type-C interface 40 is provided in the side wall of the bin body 1. The Type-C interface 40 can be used to input charging power to the charging control board 4. In addition, based on the Type-C interface 40, power can also be released to the outside, so that the device can charge other electronic devices such as mobile phones.

In practical applications, the portable camera battery charging device disclosed in the present disclosure can not only realize emergency charging of the camera batteries 100, but also pre-load an idle camera battery 100 into the receiving cavity 30 to meet the user's needs of timely battery replacement and on-demand use.

The above embodiments are merely preferred embodiments of the present disclosure but not intended to limit the present disclosure, and any modifications, equivalent replacements, improvements, etc. made within the technical scope of the present disclosure should be included within the scope of protection of the present disclosure.

1. A portable camera battery charging device, comprising a bin body (1) and a bin cover (2), wherein an inner bin (3) is fixed at the top of the bin body (1), the bin cover (2) covers the top of the inner bin (3), the edge of the bin cover (2) is hingedly connected to the bin body (1), the top of the inner bin (3) is provided with two receiving cavities (30) that match the appearances of camera batteries (100), the bottom of each receiving cavity (30) is provided with a charging plug (31) that is electrically connected with the camera battery (100) in a plug-in manner, a charging control board (4) and a built-in battery (5) are fixed in a space formed by the inner bin (3) and the bin body (1), and the charging plugs (31) and the built-in battery (5) are electrically connected to the charging control board (4) respectively.

2. The portable camera battery charging device of claim 1, wherein elastic clamping arms (32) for clamping the camera batteries (100) are respectively formed on inner walls of two sides of the receiving cavities (30).

3. The portable camera battery charging device of claim 1, wherein two indicator light boards (6) are provided on the inner side of the inner bin (3), the indicator light boards (6) are electrically connected to the charging control board (4), the indicator light boards (6) include indicator lights (60), the two indicator lights (60) pass through the top of the inner bin (3) respectively, and the two indicator lights (60) are arranged adjacent to the two receiving cavities (30) respectively.

4. The portable camera battery charging device of claim 1, wherein an upper magnet (20) is embedded in the edge of the bin cover (2), a lower magnet (33) is embedded in the edge of the inner bin (3), and the upper magnet (20) and the lower magnet (33) are aligned and magnetically attracted to each other.

5. The portable camera battery charging device of claim 1, wherein two built-in batteries (5) are provided in the space formed by the inner bin (3) and the bin body (1), and the inner walls of the bin body (1) are provided with ribs (10) which are closely matched with the built-in batteries (50).

6. The portable camera battery charging device of claim 1, wherein a Type-C interface (40) is provided on the charging control board (4), and an opening (11) aligned with the Type-C interface (40) is provided in the side wall of the bin body (1).
